(19) United States
(12) Patent Application Publication
(10) Pub. No.: US 2010/0223081 A1
(43) Pub. Date: Sep. 2, 2010

(54) VIRTUAL BUSINESS MODEL FOR SPECIFIC BUILDING ENERGY AND SUSTAINABILITY AUDITS

(76) Inventor: Mario A. ESPINO, JR., Miami, FL (US)

Correspondence Address: ALBERT BORDAS, P.A., 5975 SUNSET DRIVE, SUITE 607, MIAMI, FL, 33143, US

(21) Appl. No.: 12/566,274

(22) Filed: Sep. 24, 2009

(51) Int. Cl. G06Q 10/00; G06Q 30/00; G06F 17/30; G06Q 50/00

(52) U.S. Cl. 705/7; 705/26; 705/28

(57) ABSTRACT

An energy audit and sustainability analysis business model, comprising an equipment/appliances/materials database, a member/audits/sales member customer database, a certification Leadership in Energy and Environmental Design/Energy Star consulting services/construction services database, a programming computer, and an auditing system computer software that produces a report. The energy audit and sustainability analysis business model allows comparisons of a non-green building structure to a potential green building structure. The auditing system allows for data in three areas to be analyzed to give a real comprehensive view of overall saving, sustainability, and individual reductions in environmental footprints.

### BACKGROUND OF THE INVENTION

1. Field of the Invention

The present invention relates to business models, and more particularly, to virtual business models for specific building energy and sustainability audits.

2. Description of the Related Art

Environmentalism is a broad philosophy and social movement regarding concerns for environmental conservation and improvement of the state of the environment. Environmentalism and environmental concerns are often represented with the color green. Environmentalism can also be defined as a social movement that seeks to influence the political process by lobbying, activism, and education in order to protect natural resources and ecosystems. In recognition of humanity as a participant in ecosystems, the environmental movement is centered on ecology, health, reduction of dependency on fuels, and the creation of alternate sources of energy.

An environmentalist is a person who may advocate the sustainable management of resources and stewardship of the natural environment through changes in public policy or individual behavior. In various ways (for example, grassroots activism and protests), environmentalists and environmental organizations seek to give the natural world a stronger voice in the future of our planet.

Therefore, a “forward thinking” movement among all concerned with the environment, construction, commerce, and fashionable living, is to go “green”. The general opinion of the environmentalists and environmental organizations is that if we do not take care of our environment, our world will soon become “grey”.

The United States has established several sustainable design organizations and programs in green building. The U.S. Green Building Council, defined as (“USGBC”) is a non-profit trade organization that promotes sustainability in how buildings are designed, built and operated. The USGBC is best known for the development of the Leadership in Energy and Environmental Design, defined as (“LEED”) rating system and (“GREENBUILD”), a green building conference that promotes the green building industry. As of September 2008, USGBC has more than 17,000 member organizations from every sector of the building industry and works to promote buildings that are environmentally responsible, profitable and healthy places to live and work. To achieve this it has developed a variety of programs and services, and works closely with key industry and research organizations and federal, state and local government agencies. USGBC also offers a host of educational opportunities, including workshops and Web-based seminars to educate the public and industry professionals on different elements of the green building industry, from the basics to more technical information. Through its Green Building Certification Institute, USGBC offers industry professionals the chance to develop expertise in the field of green building and to receive accreditation as green building professionals.

The National Association of Home Builders, a trade association representing homebuilders, remodelers and suppliers to the industry, has created a voluntary residential green building program known as (“NAHB GREEN”). The program includes an online scoring tool, national certification, industry education, and training for local verifiers. The Green Building Initiative, defined as (“GBI”) is a non-profit network of building industry leaders working to mainstream building approaches that are environmentally progressive, but also practical and affordable for builders to implement. The GBI has developed a web-based rating tool called Green Globes. The United States Environmental Protection Agency's Energy Star program rates commercial buildings for energy efficiency and provides Energy Star qualifications for new homes that meet its standards for energy efficient building design.

The Collaborative for High Performance Schools, defined as (“CHPS”) is a non-profit green rating program specifically for K-12 schools. CHPS addresses energy efficiency and additional design considerations fostering healthy and environmentally responsible school buildings. On Jun. 4, 2008, the U.S. House of Representatives passed the “21st Century Green High-Performing Public School Facilities Act,” which would commit over $20 billion of funding over the next five years to high performance schools. CHPS is recognized as one of the standards that projects would need to meet in order to qualify for funding.

The American Recovery and Reinvestment Act of 2009 has made available not less than $4.5 billion for measures necessary to convert General Services Administration, defined as (GSA) facilities to High-Performance Green Buildings, as defined in the Energy Independence and Security Act of 2007. As an example, San Francisco Mayor Gavin Newsom approved a green building ordinance in early August 2008 that imposes strict requirements on newly constructed residential and commercial buildings within the city, as well as building renovations.

For commercial buildings and high-rise residential buildings, the ordinance adds in requirements from the U.S. Green Building Council's LEED rating system. Starting in November 2009 (if the California Energy Commission has approved the legislation), new permit applications for high-rise residential buildings must include documentation to achieve LEED certification (or 50 GreenPoints), and starting in 2010, they must include documentation to achieve LEED Silver certification (or 75 GreenPoints). A number of specific LEED standards must also be met for landscaping, water use reduction, and construction debris management. Mid-size commercial buildings don't need to meet LEED certification requirements but must meet LEED standards for building commissioning, landscaping, water use, and construction debris management starting in 2009, and must meet enhanced commissioning standards and tighter water use requirements starting in 2010. Beginning in 2012, the buildings must also meet LEED standards for the use of on-site renewable energy or the purchase of renewable energy credits.

The toughest requirements apply to large commercial buildings. Starting in November 2009, new permit applications for high-rise residential building must submit documentation to achieve LEED certification, and that requirement ratchets up to LEED Silver in 2009 and LEED Gold in 2012. There are also requirements to meet additional LEED standards, nearly equal to those for mid-size commercial buildings. Finally, for new large commercial interiors and major alterations to existing buildings, new permit applications must include documentation to achieve the same LEED rating requirements as for new large commercial buildings, and must also meet the LEED standards for materials that emit low levels of indoor pollutants. All new buildings must earn additional rating points if an older building was demolished to make room for it, and they must earn even higher points if the demolished building was historical. Building projects can also earn extra points by retaining historical features of the previous building.

Earning LEED credits within this framework is becoming cost neutral for most hotel developers, especially in the Napa Valley where the industry has caught up to speed. Since at least March 2008, green property builders have been giving them “real figures on what it costs to build a green property” after developer tax incentives.

Charlottesville, Va. became one of the first small towns in the United States to enact green building legislation. This presents a significant shift in construction and architecture as LEED regulations have formerly been focused on commercial construction. If US homeowner interest grows in “green” residential construction, the companies involved in the production and manufacturing of LEED building materials will become likely candidates for tomorrow's round of private equity and initial public offering, defined as (“IPO”), investing.

In 2005, Washington State became the first state in the United States to enact green building legislation. According to the law, all major public agency facilities with a floor area exceeding 5,000 square feet (465 m²), including state funded school buildings, are required to meet or exceed LEED standards in construction or renovation. The projected benefits from this law are 20% annual savings in energy and water costs, 38% reduction in wastewater production and 22% reduction in construction waste.

Therefore, it is clear that green properties are in a higher demand and have better value than those that are not. USGBC hopes that their standards will soon be incorporated into all future construction. The use of USGBC standards and Energy Star ratings to go green has been proven not to add substantial costs in new buildings. The prior art describing the closest subject matter above provides for a number of more or less complicated features that fail to solve the problem in an efficient and economical way. None of the prior art suggests the novel features of the present invention.

### SUMMARY OF THE INVENTION

The present invention is defined as a virtual business model for specific building energy and sustainability audits. Novel features of the present invention include an auditing system that allows comparisons of a non-green building structure to a potential green building structure. The auditing system allows for data in three areas to be analyzed to give a real comprehensive view of overall saving, sustainability, “cost if” replacements installed by DIY or DIP that is tracked by a tracking system computer software, defined as (“4U GREEN TRACKER”), and individual reductions in environmental footprints. This auditing system is defined as (“TRIPLE GREEN VIEW AUDIT”).

Novel features of the present invention also includes a website. Revenues derive from membership, an online shopping cart defined as (“4U GREEN SHOPPER”) where purchases of products including equipment, appliances, and materials are made on-line, and advertising by manufacturers of equipment, appliances, and materials.

Another novel feature of the present invention also includes television programming with instructional information on how to utilize the present invention, thus showing people how the website actually works, utilizing real members and following a process through.

More specifically, the instant invention is a virtual business model for specific building energy and sustainability audits.

It is therefore one of the main objects of the present invention to provide a virtual business model for specific building energy and sustainability audits that may be utilized for commercial, residential, and institutional building structures by professionals and non-professionals.

It is another object of the present invention to provide a virtual business model for specific building energy and sustainability audits that may be utilized for new or existing building structures.

It is another object of the present invention to provide a virtual business model for specific building energy and sustainability audits that includes an auditing system that allows comparisons of a non-green building structure to a potential green building structure.

It is yet another object of the present invention to provide a virtual business model for specific building energy and sustainability audits that allows for data in three areas to be analyzed to give a real comprehensive view of overall saving, sustainability, individual reductions in environmental footprints, and return on investment patterns for predetermined time periods such as 5, 10, and 15 years.

It is yet another object of the present invention to provide a virtual business model for specific building energy and sustainability audits that includes a website that earns revenue from membership; an online shopping cart where purchases of equipment, appliances, and materials are made on-line; and advertising by manufacturers of equipment, appliances, and materials.

It is yet another object of the present invention to provide a virtual business model for specific building energy and sustainability audits that includes television programming with instructional information on how to utilize the present invention, thus showing people how the website actually works, utilizing real members and following a process through, whereby the television programming allows for marketing the products to all viewers across various countries and close captioned in respective languages.

It is yet another object of the present invention to provide a virtual business model for specific building energy and sustainability audits that permits analysis of cost savings from use of less energy, and the possibility of creating new sources of energy to run building structures.

It is yet another object of the present invention to provide a virtual business model for specific building energy and sustainability audits having an ultimate goal to have the building structures be self-sustaining.

It is yet another object of the present invention to provide a virtual business model for specific building energy and sustainability audits that gives a member an opportunity to determine a time period required to recover an investment based on selected items and/or categories selected to go green.

It is yet another object of the present invention to provide a virtual business model for specific building energy and sustainability audits having an auditing system to produce data of cost of equipment/materials/appliances, installation costs, and energy savings.

It is yet another object of the present invention to provide a virtual business model for specific building energy and sustainability audits that produces exact conditions whether existing or future with actual replacement costs, energy savings, and Do It Yourself, “(DIY”) or Do It By Professional (“DIP”) suggestions, while a separate guide for each install is provided.

It is yet another object of the present invention to provide a virtual business model for specific building energy and sustainability audits having a tracking system, defined as (“4U GREEN TRACKER”) that produces a simulated blueprint of the selected building structure that identifies areas of the building structure that have been analyzed and what sections are still pending.

It is still another object of the present invention to provide a virtual business model for specific building energy and sustainability audits offering consulting services that is available for those projects requiring intensive time to complete audits, or if someone requires design build services.

It is still another object of the present invention to provide a virtual business model for specific building energy and sustainability audits offering certification LEED/Energy Star consulting services/construction services.

It is still another object of the present invention to provide a virtual business model for specific building energy and sustainability audits offering information regarding Federal, State, and Local incentives to purchase goods and services.

It is still another object of this invention to provide such a business method that is inexpensive to implement and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a flow chart of an energy audit and sustainability analysis business model, object of the present invention.

FIG. 1A represents a flow chart of equipment/appliances/materials database 20 sectioned into three classes of data.

FIG. 1B represents a flow chart of member/audits/sales member customer database 40 sectioned into three classes of data.

FIG. 1C represents a flow chart of LEED/Energy Star consulting services/construction services database 60 sectioned into four classes of data.

### DETAILED DESCRIPTION OF THE PREFERRED EMBODIMENT

Referring now to the drawings, the present invention is a virtual business model for specific building energy and sustainability audits, and is generally referred to with numeral 10. It can be observed that it basically includes equipment/appliances/materials database 20, member/audits/sales member customer database 40, certification Leadership in Energy and Environmental Design, defined as (“LEED”)/the United States Environmental Protection Agency's Energy Star consulting services/construction services database 60, programming computer 80, and an auditing system computer software that produces a report defined as (“TRIPLE GREEN VIEW AUDIT”) 180.

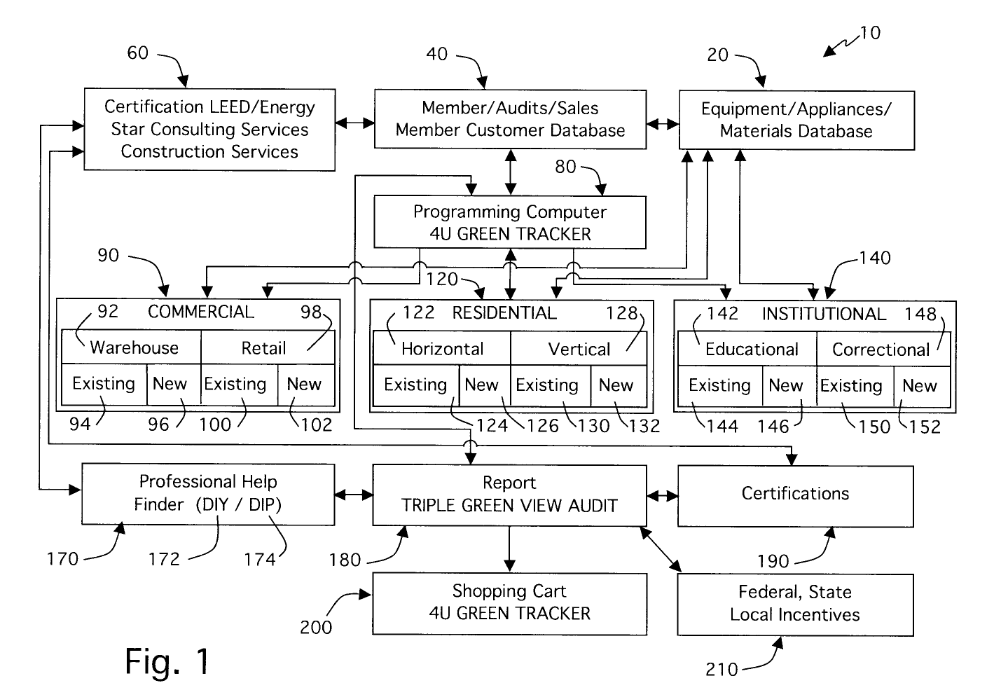

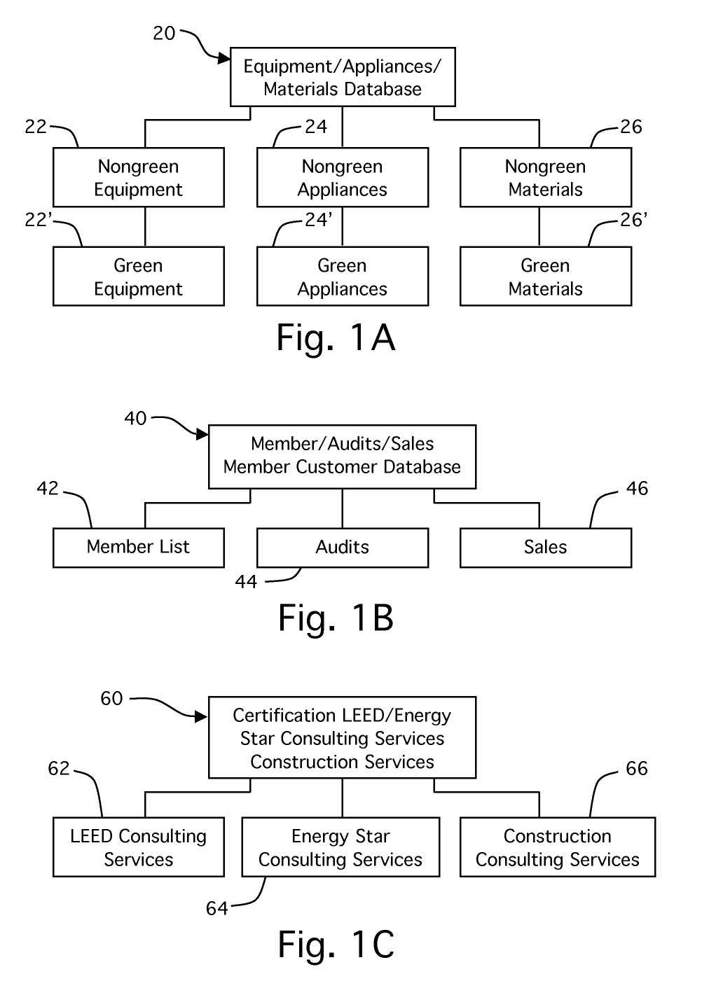

As seen in FIG. 1, equipment/appliances/materials database 20 is a first database system sectioned into three classes of data as seen in FIG. 1A, non-green equipment 22 and green equipment 22′, non-green appliances 24 and green appliances 24′, and non-green materials 26 and green materials 26′.

Non-green equipment 22 is identified by: category, manufacturer, model number, capacity, expected life, and energy usage by hour. Green equipment 22′ is identified by: category, manufacturer, model number, capacity, expected life, and energy usage by hour. Non-green equipment 22 and green equipment 22′ can be, but are not limited to, sinks, toilets, light bulbs, essentially any equipment that is not defined as non-green appliances 24 and green appliances 24′, or non-green materials 26 and green materials 26′.

Non-green appliances 24 are identified by: category, manufacturer, model number, capacity, expected life, and energy usage by hour. Green appliances 24′ are identified by: category, manufacturer, model number, capacity, expected life, and energy usage by hour. Non-green appliances 24 and green appliances 24′ can be, but are not limited to, refrigerators, stoves, microwaves, electric dishwashers, essentially any appliances that are not defined as non-green equipment 22 and green equipment 22′, or non-green materials 26 and green materials 26′.

Non-green materials 26 are identified by: category, manufacturer, model number, and expected life. Green materials 26′ are identified by: category, manufacturer, model number, and expected life. Non-green materials 26 and green materials 26′ can be, but are not limited to, roofing materials, insulation, materials for walls, ceilings, separators, and flooring materials, essentially any materials that are not defined as non-green equipment 22 and green equipment 22′, or non-green appliances 24 and green appliances 24′.

As also seen in FIG. 1, member/audits/sales member customer database 40 is a second database system sectioned into three classes of data as seen in FIG. 1B, member list 42, audits 44, and sales 46. Member list 42 comprises each member name and identification. Member list 42 may store different levels of participation and access within instant invention 10 for individuals, architects, contractors, developers, and property managers. Audits 44 comprise and track each TRIPLE GREEN VIEW AUDIT 180, also defined as audit, produced that a member from member list 42 requests. Sales 46 comprise and track each sale made by the member from member list 42. Member/audits/sales member customer database 40 may also store member's information as it pertains to certification LEED/Energy Star consulting services/construction services database 60 including professional help finder 170, certifications database 190, and Federal/State/Local incentive database 210. In addition member/audits/sales member customer database 40 may also comprise records and/or data from services acquired/requested/or purchased by the user of present invention 10. Such services originating from instant invention 10, and specifically certification LEED/Energy Star consulting services/construction services database 60. In addition sales 46 may also comprise records or data of membership fees paid by the user of present invention 10, and fees paid for use of services acquired/requested/or purchased by the user of present invention 10. Such services originating from instant invention 10, and specifically certification LEED/Energy Star consulting services/construction services database 60.

As also seen in FIG. 1, certification LEED/Energy Star consulting services/construction services database 60 is a third database system sectioned into four classes of data as seen in FIG. 1C, LEED consulting services 62, Energy Star rating services 64, construction services 66, and professional help finder 170.

LEED consulting services 62 lists qualified individuals that may perform LEED consulting services as recommended by the Leadership in Energy and Environmental Design, Energy Star rating services 64 lists qualified individuals that may perform Energy Star consulting services as recommended by the United States Environmental Protection Agency, and construction services 66 lists qualified individuals that may perform construction consulting services.

As also seen in FIG. 1, professional help finder 170 is an extension of Certification LEED/Energy Star consulting services/construction services database 60. Professional help finder 170 is sectioned into two classes of data, Do It Yourself, defined as “(DIY”) 172; and Do It By Professional, defined as (“DIP”) 174. DIY 172 lists information to assist with the installation of green equipment 22′, green appliances 24′, and green materials 26′. DIP 174 lists qualified individuals to install green equipment 22′, green appliances 24′, and green materials 26′ at predetermined prices. The DIP 174 qualified individuals are checked for required licenses and insurance. Certification LEED/Energy Star consulting services/construction services database 60 may also comprise lists of individuals that may perform “Construction” and/or “Design Build” services.

As also seen in FIG. 1, programming computer 80 is the computer that performs all the functions required to operate instant invention 10, comprising typical electronic circuits and input/output devices known as “hardware” including CPU, input, output and memory. The CPU (central processing unit) executes programs (“software”) that tell the computer what to do. Input and output (I/O) devices allow the computer to communicate with the user and the outside world via the Internet. It is noted that in the preferred embodiment, instant invention 10 works via the World-Wide-Web, also defined as the Internet. Multiple arrows illustrated in FIG. 1, defining the virtual business model for specific building energy and sustainability audits, represent Internet communications.

Programming computer 80 is also a computer system having source code, a tracking system computer software, defined as (“4U GREEN TRACKER”). Programming computer 80 also produces a simulated blueprint of a selected building structure that identifies areas of the building structure that have been analyzed and what sections are still pending. The simulated blueprint and information therein can be stored within member/audits/sales member customer database 40.

As also seen in FIG. 1, instant invention 10 further comprises commercial building structure database 90 that is a fourth database system sectioned into two classes of data, and each of the two classes of data having two subclasses of data. Specifically, commercial building structure database 90 comprises warehouse class 92 having existing subclass 94 and new subclass 96; and retail class 98 having existing subclass 100 and new subclass 102. Warehouse class 92 defines a building structure designed for warehouse operations, and retail class 98 defines a building structure designed for retail operations.

As also seen in FIG. 1, instant invention 10 further comprises residential building structure database 120 that is a fifth database system sectioned into two classes of data, and each of the two classes of data having two subclasses of data. Specifically, residential building structure database 120 comprises horizontal class 122 having existing subclass 124 and new subclass 126; and vertical class 128 having existing subclass 130 and new subclass 132. Horizontal class 122 defines a single or multi-level building structure such as a single-story home, duplex, triplex, or townhouse that is at some point attached to earth, and vertical class 128 defines a multi-level building structure such as an apartment building, apartment complex, or condominiums having units not themselves attached to earth.

As also seen in FIG. 1, instant invention 10 further comprises institutional building structure database 140 that is a sixth database system sectioned into two classes of data, and each of the two classes of data having two subclasses of data. Specifically, institutional building structure database 140 comprises educational class 142 having existing subclass 144 and new subclass 146; and correctional class 148 having existing subclass 150 and new subclass 152. Educational class 142 defines a building structure used as educational facilities such as schools, vocational schools, and training centers; and correctional class 148 defines a building structure used as a jail, holding facility, or prison.

As also seen in FIG. 1, instant invention 10 further comprises an auditing system computer software that allows comparisons of a non-green building structure to a potential green building structure. The auditing system computer software produces the TRIPLE GREEN VIEW AUDIT 180 that allows for data in three areas to be analyzed to give a real comprehensive view of overall saving, sustainability, installation costs, and individual reductions in environmental footprints pre and post the TRIPLE GREEN VIEW AUDIT 180.

As also seen in FIG. 1, certifications database 190 is a seventh database system. Certifications database 190 lists information rating systems such as, but not limited to, the LEED rating systems and the Energy Star rating systems.

As also seen in FIG. 1, instant invention 10 further comprises an online shopping cart, defined as (“4U GREEN SHOPPER”) 200, where purchases of green equipment 22′, green appliances 24′, and green materials 26′ are made on-line.

As also seen in FIG. 1, Federal/State/Local incentive database 210 is an eighth database system. Federal/State/Local incentive database 210 lists information regarding Federal, State, and Local incentives to purchase services defined in certification LEED/Energy Star consulting services/construction services database 60; and/or professional help finder 170; and/or green equipment 22′, green appliances 24′, and green materials 26′.

In operation, respective data is entered into and maintained current within the first, second, third, fourth, fifth, sixth, seventh, and eighth database systems defined above.

A user of present invention 10 accesses member/audits/sales member customer database 40, and specifically member list 42, to provide his/her name to define a member name and identification, and select services desired.

Once a member, the user of present invention 10 may select a desirable building structure database to prepare the TRIPLE GREEN VIEW AUDIT 180, specifically, commercial building structure database 90, residential building structure database 120, or institutional building structure database 140, and begins to answer general questions regarding same.

It is noted that weather, time zone, shading, costs of energy, and the orientation of building structure relative to the sun may also be used as variables for the auditing system computer software.

The user of present invention 10 may then determine the scope of the TRIPLE GREEN VIEW AUDIT 180, specifically whether he/she desires to review equipment, and/or appliances, and/or materials from equipment/appliances/materials database 20, and specifically green equipment 22′, and/or green appliances 24′, and/or green materials 26′, and continues to answer more specific questions regarding same.

Depending on the selection above, the user of present invention 10 then accesses equipment/appliances/materials database 20, and specifically non-green equipment 22, and/or non-green appliances 24, and/or non-green materials 26 to select the equipment, and/or appliances, and/or materials the user desires to replace from the commercial building structure database 90, residential building structure database 120, or institutional building structure database 140.

It is noted that the user of present invention 10 may select the non-green equipment 22, and/or non-green appliances 24, and/or non-green materials 26, whereby equipment/appliances/materials database 20 provides a pre-select list for the user of present invention 10 to select from.

The user of present invention 10 then selects the applicable non-green equipment 22, and/or non-green appliances 24, and/or non-green materials 26 from equipment/appliances/materials database 20. As the user of present invention 10 makes the selection(s) above, the auditing system computer software produces the TRIPLE GREEN VIEW AUDIT 180, whereby alternative respective green equipment 22′, and/or green appliances 24′, and/or green materials 26′ are identified and illustrated to the user of present invention 10. It is understood that the resulting alternative respective green equipment 22′, and/or green appliances 24′, and/or green materials 26′ are the most efficient sustainable replacements available. The user of present invention 10 also can choose green equipment 22′, and/or green appliances 24′, and/or green materials 26′ from particular desired manufacturers.

In the TRIPLE GREEN VIEW AUDIT 180, commercial building structure database 90, residential building structure database 120, and institutional building structure database 140 each have a printable version of the questions to the user of present invention 10, making it a financial tool for banks user friendly.

The auditing system computer software then retrieves a manufacture's suggested retail price, useful life, and energy savings per hour for each of the resulting alternative respective green equipment 22′, and/or green appliances 24′, and/or green materials 26′.

The TRIPLE GREEN VIEW AUDIT 180 identifies the resulting alternative respective green equipment 22′, and/or green appliances 24′, and/or green materials 26′ that are more efficient, last longer, and saves energy.

The TRIPLE GREEN VIEW AUDIT 180 produces a side-by-side comparison of the non-green equipment 22, and/or non-green appliances 24, and/or non-green materials 26 as compared to the resulting alternative respective green equipment 22′, and/or green appliances 24′, and/or green materials 26′.

The TRIPLE GREEN VIEW AUDIT 180 also produces net gain or loss information over predetermined time periods. Such predetermined time periods can be 5, 10, and 15 years as an example.

The TRIPLE GREEN VIEW AUDIT 180 also produces Return on Investment figures. This is accomplished by providing predetermined time periods for projecting. Such predetermined time periods can be 5, 10, and 15 years as an example. This allows the user of present invention 10 to project costs and savings, giving the user of present invention 10 the ability to customize his/her TRIPLE GREEN VIEW AUDIT 180.

Upon producing the TRIPLE GREEN VIEW AUDIT 180, an electronic folder is created within the user's member list 42 for storing the user's selections of the various databases of instant invention 10. As mentioned above, in the TRIPLE GREEN VIEW AUDIT 180, commercial building structure database 90, residential building structure database 120, and institutional building structure database 140 each have a printable version of the questions to the user of present invention 10, making it a financial tool for banks user friendly. The TRIPLE GREEN VIEW AUDIT 180 can also be utilized as a quote or proposal for banks, in order to obtain bank lending to go green.

It is noted that the TRIPLE GREEN VIEW AUDIT 180 may be based on one particular non-green equipment 22 and green equipment 22′, or non-green appliances 24 and green appliances 24′, or non-green materials 26 and green materials 26′; or a group of pre-selected non-green equipment 22 and green equipment 22′, and/or non-green appliances 24 and green appliances 24′, and/or non-green materials 26 and green materials 26′; or entire groups of non-green equipment 22 and green equipment 22′, and non-green appliances 24 and green appliances 24′, and non-green materials 26 and green materials 26′. For example, the user can select a gas cook top in a kitchen, all kitchen appliances, or the entire building structure.

Once the user of present invention 10 is finished selecting items or pre selected categories, and all questions are answered, he/she can proceed to finalize his/her TRIPLE GREEN VIEW AUDIT 180. When the TRIPLE GREEN VIEW AUDIT 180 is finalized, the user of present invention 10 accesses 4U GREEN SHOPPER 200 to produce specific data sheets as well as an installation guide and cost to install.

This is a benefit for those in the construction industry, since it takes so much time to find and produce submittals (datasheets). At this point, the user of present invention 10 may also access professional help finder 170 and select DIY 172. The professional help finder 170 may provide material/data sheets, installation guides, and cost to install the resulting alternative respective green equipment 22′, and/or green appliances 24′, and/or green materials 26′. The user of present invention 10 may also access professional help finder 170 and select DIP 174. In DIP 174, the user of present invention 10 can find contractors willing to perform portions of work to be done. Contractors willing to perform work for the user in their geographical area can agree on pricing.

At this point, the user of present invention 10 may also access certification LEED/Energy Star consulting services/construction services database 60, certifications database 190, and/or Federal/State/Local incentive database 210 to identify needs and/or levels required to achieve a desired level, certification, and/or green accreditation such as a Silver, Gold or Platinum rating of their building structure, and see who from the Federal/State/Local incentive database 210 can reduce expenses with incentives.

4U GREEN SHOPPER 200 is a typical online shopping cart. All transactions are done utilizing maximum safeguards available in the industry for the protection of the members, and payment information. 4U GREEN SHOPPER 200 provides shipping charges or locations in which a member can pick up their order, as well as keeps track of the status of all sales that have been done.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A virtual business model for specific building energy and sustainability audits, comprising:
A) a first database system sectioned into first classes of first data, said first classes of first data includes equipment, appliances, and materials;
B) a second database system sectioned into second classes of second data, said second classes of second data include members, audits, and sales;
C) a third database system sectioned into four classes of third data, said four classes of third data include certification services, consulting services, construction services, and professional help finder;
D) a computer system having tracking system computer software;
E) a fourth database system defining a commercial building structure database;
F) a fifth database system defining a residential building structure database;
G) a sixth database system defining an institutional building structure database;
H) an auditing system computer software that allows comparisons of a non-green building structure to a potential green building structure;
I) a seventh database system defining a certifications database that lists certification rating system information;
J) an online shopping cart where purchases of said equipment, said appliances, and said materials are made on-line; and
K) an eighth database system defining a incentives database that lists information regarding Federal, State, and Local incentives to purchase said equipment, said appliances, and said materials.

2. The virtual business model for specific building energy and sustainability audits set forth in claim 1, further characterized in that said equipment comprises non-green equipment and green equipment.

3. The virtual business model for specific building energy and sustainability audits set forth in claim 2, further characterized in that said non-green equipment and said green equipment is identified by category, manufacturer, model number, capacity, expected life, and energy usage by hour.

4. The virtual business model for specific building energy and sustainability audits set forth in claim 1, further characterized in that said appliances comprise non-green appliances and green appliances.

5. The virtual business model for specific building energy and sustainability audits forth in claim 4, further characterized in that said non-green appliances and said green appliances are identified by category, manufacturer, model number, capacity, expected life, and energy usage by hour.

6. The virtual business model for specific building energy and sustainability audits set forth in claim 1, further characterized in that said materials comprise non-green materials and green materials.

7. The virtual business model for specific building energy and sustainability audits set forth in claim 6, further characterized in that said non-green materials and said green materials are identified by category, manufacturer, model number, and expected life.

8. The virtual business model for specific building energy and sustainability audits set forth in claim 1, further characterized in that said second database system comprises member names and identification, audit tracking of said members, and sales tracking of purchases made on said online shopping cart.

9. The virtual business model for specific building energy and sustainability audits set forth in claim 1, further characterized in that said certification services, said consulting services, and said construction services list qualified individuals that may perform green certification, consulting, and construction consulting services respectively.

10. The virtual business model for specific building energy and sustainability audits set forth in claim 1, further characterized in that said tracking system computer software produces a simulated blueprint of a selected building structure that identifies areas of said building structure that have been analyzed and what sections are still pending.

11. The virtual business model for specific building energy and sustainability audits set forth in claim 1, further characterized in that said Do It Yourself lists information to assist with installation of green equipment, green appliances, and green materials, and said Do It Professional lists qualified individuals to install said green equipment, said green appliances, and said green materials.

12. The virtual business model for specific building energy and sustainability audits set forth in claim 1, further characterized in that said auditing system computer software produces a report of said comparisons of said non-green building structure to said potential green building structure.

13. The virtual business model for specific building energy and sustainability audits set forth in claim 12, further characterized in that said report identifies resulting alternative respective green equipment, and/or green appliances, and/or green materials that are more efficient, last longer, and save energy.

14. The virtual business model for specific building energy and sustainability audits set forth in claim 12, further characterized in that said report produces a side-by-side comparison of the non-green equipment, and/or non-green appliances, and/or non-green materials as compared to resulting alternative respective green equipment, and/or green appliances, and/or green materials.

15. The virtual business model for specific building energy and sustainability audits set forth in claim 12, further characterized in that said report produces net gain or loss information over predetermined time periods.

16. The virtual business model for specific building energy and sustainability audits set forth in claim 15, further characterized in that said predetermined time periods can be 5, 10, and 15 years.

17. The virtual business model for specific building energy and sustainability audits set forth in claim 12, further characterized in that said report produces return on investment figures by providing predetermined time periods for projecting project costs and savings.

18. The virtual business model for specific building energy and sustainability audits set forth in claim 12, further characterized in that said report is customized.

19. The virtual business model for specific building energy and sustainability audits set forth in claim 1, further characterized in that said professional help finder includes Do It Yourself, and Do It By Professional.
